(19) United States
(12) Patent Application Publication
(10) Pub. No.: US 2016/0223065 A1
(43) Pub. Date: Aug. 4, 2016

(54) Rack

(71) Applicant: Apex Dynamics, Inc., Taichung City (TW)

(72) Inventor: Robin C.S. Chang, Taichung City (TW)

(21) Appl. No.: 14/611,294

(22) Filed: Feb. 2, 2015

(51) Int. Cl. F16H 55/26

(52) U.S. Cl. CPC F16H 55/26

(57) ABSTRACT

A rack includes a base and a toothed portion. The base includes two lateral faces. The toothed portion extends on the base and includes two lateral faces each extending from a corresponding one of the lateral faces of the base at an angle. Thus, there is a fold line extending between each of the lateral faces of the toothed portion and the corresponding one of the lateral faces of the base.

### BACKGROUND OF INVENTION

1. Field of Invention

The present invention relates to a rack and, more particularly, to a rack that includes, on each side, an upper lateral face extending from a lower lateral face at an angle.

2. Related Prior Art

Referring to FIG. 5, a conventional rack 9 includes a toothed portion 94 formed on a base 92. The toothed portion 94 includes teeth 944 separated by valleys 942. The toothed portion 94 and the base 92 are made of same hardness when the conventional rack 9 is cast or forged. Then, the toothed portion 94 is hardened. Thus, the hardness of the toothed portion 94 gets higher than the hardness of the base 92 that remains. The toothed portion 94 is expect to survive wearing against a toothed portion of a pinion for example. The conventional rack 9 includes two lateral faces 92 both extending to the toothed portion 94 from the base 92. That is, the toothed portion 94 shares the same lateral faces with the base 92. However, each lateral face includes an upper portion of higher hardness and a lower portion of lower hardness. Each tooth 944 includes two edges in each lateral face.

Referring to FIG. 6, each lateral face is ground with a grinding wheel 24. The grinding wheel 24 is inevitably be worn by the edges of the teeth 944 when the grinding wheel 24 is used to polish the upper portion of each lateral face. Thus, the periphery of the grinding wheel 24 turns far from a true circle. Such a periphery of the grinding wheel 24 inevitably jeopardizes the flatness of the lower portion of the lateral face when the grinding wheel 24 is used to polish the lower portion of each lateral face.

Moreover, the upper and lower portions of each lateral face should be ground by different grinding wheels. However, the boundary between the upper and lower portions of each lateral face is unclear. Hence, even if a worker bothers to polish the upper and lower portions of each lateral face with two grinding wheels, respectively, the worker will inevitably polish part of the upper portion of each lateral face with a softer grinding wheel or polish part of the lower portion of each lateral face with a harder grinding wheel.

The present invention is therefore intended to obviate or at least alleviate the problems encountered in prior art.

### SUMMARY OF INVENTION

It is the primary objective of the present invention to provide a rack that can precisely be finished.

To achieve the foregoing objective, the rack includes a base and a toothed portion. The base includes two lateral faces. The toothed portion extends on the base and includes two lateral faces each extending from a corresponding one of the lateral faces of the base at an angle. Thus, there is a fold line extending between each of the lateral faces of the toothed portion and the corresponding one of the lateral faces of the base.

An advantage of the rack of the present invention is that the lateral faces of the base can properly be polished with a grinding wheel while the lateral faces of the toothed portion can properly be polished with another grinding wheel.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a partial, perspective view of a rack according to the preferred embodiment of the present invention;

FIG. 2 is a front view of the rack shown in FIG. 1;

FIG. 3 is a front view of a grinding wheel for finishing the rack shown in FIG. 2;

FIG. 4 is a front view of another grinding wheel for finishing the rack shown in FIG. 2;

FIG. 5 is a partial, perspective view of a conventional rack; and

FIG. 6 is a front view of a grinding wheel for finishing the conventional rack shown in FIG. 5.

### DETAILED DESCRIPTION OF PREFERRED EMBODIMENT

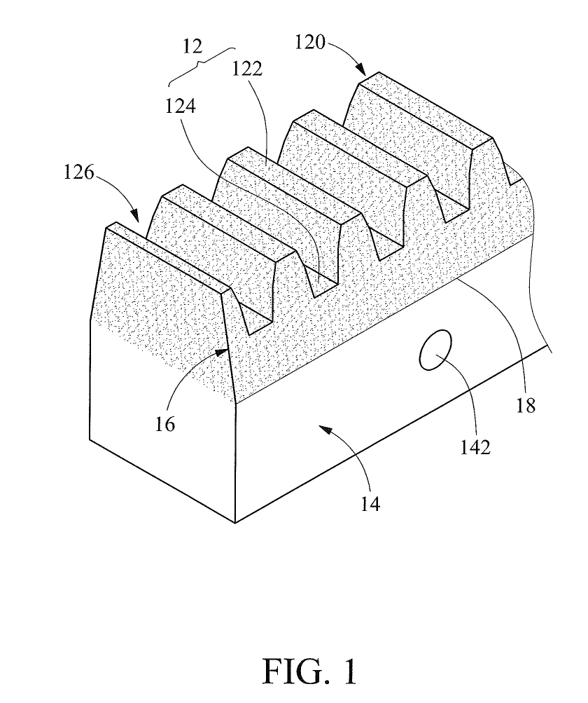

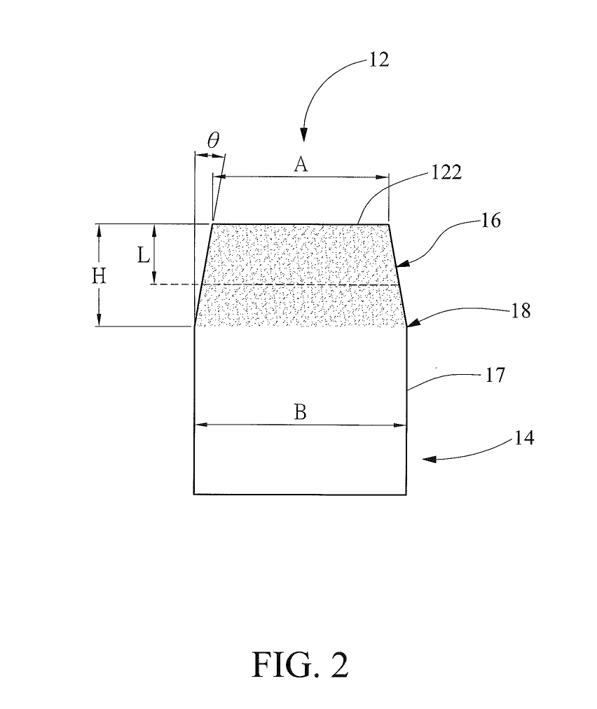

Referring to FIGS. 1 and 2, a rack includes a toothed portion 12 formed on a base 14 according to the preferred embodiment of the present invention. The base 14 includes an aperture 142. The base 14 is formed with two lateral faces 17 that preferably extend parallel to each other.

The toothed portion 12 is formed with teeth 120 separated by spaces 126. Each tooth 120 is formed with a top land 122. There is a bottom land 124 in each space 126. The toothed portion 12 Further includes two lateral faces 16 each extending from a corresponding lateral face 17 of the base 14.

There is a fold line 18 extending between each lateral face 16 and the corresponding lateral face 17. The fold line 18 is clear boundary between each lateral face 16 and the corresponding lateral face 17.

The toothed portion 12 and the base 14 are made of same hardness when the rack is cast or forged. Then, the toothed portion 12 is hardened. Thus, the hardness of the toothed portion 12 gets higher than the hardness of the base 14 that remains. That is, the hardness of the lateral faces 16 is higher than the hardness of the lateral faces 17. The toothed portion 12 is expected to survive wearing against a toothed portion of a pinion for example.

Referring to FIG. 2 in particular, the top land 122 of each tooth 120 is made of a width A. The width A is the shortest distance between the lateral faces 16. The base 14 is made of a width B. The width B is the shortest distance between the lateral faces 17. The width A is smaller than the width B. Each tooth 120 is made of a height L. The toothed portion 12 is made of a height H. The height L is smaller than or identical to the height H. Each fold line 18 extends past the bottom lands 124 where the height L is identical to the height H.

There is an angle θ between each lateral face 16 and the corresponding lateral face 17. The angle θ is larger than 0° and smaller than 20°. The angle θ is preferably 5°.

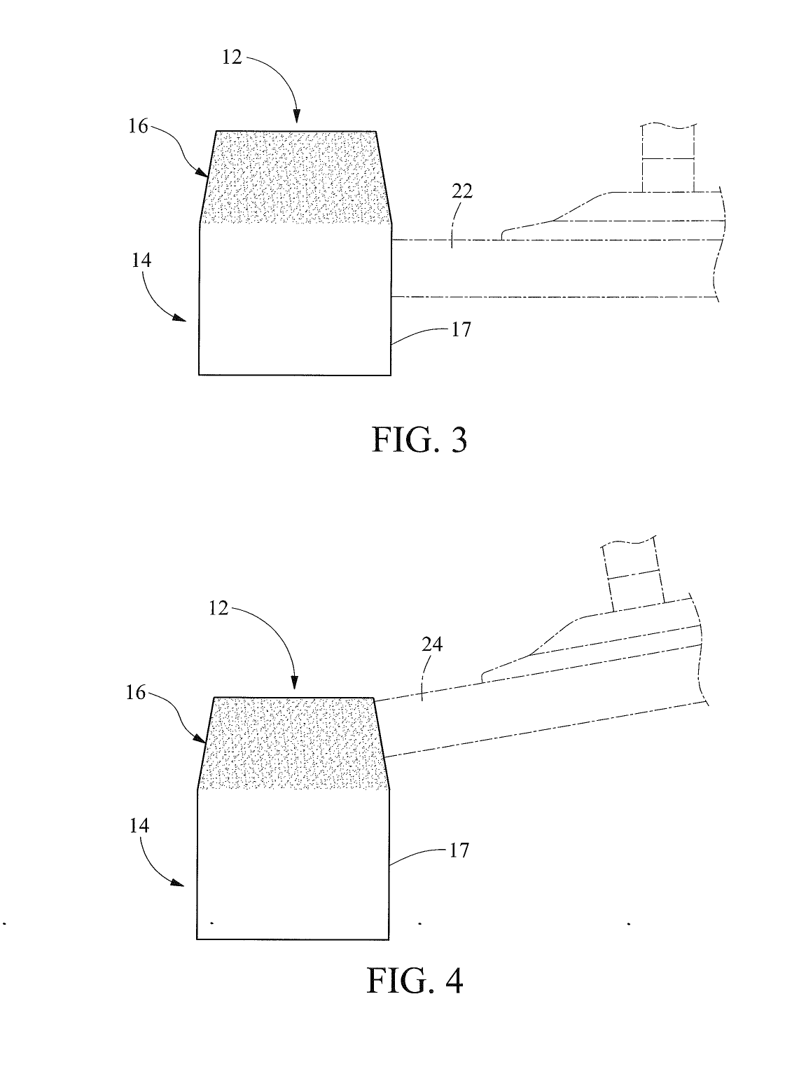

Referring to FIG. 3, a grinding wheel 22 is used to polish each of the lateral faces 17. An axle (not numbered) for rotating the grinding 22 is directed substantially vertically.

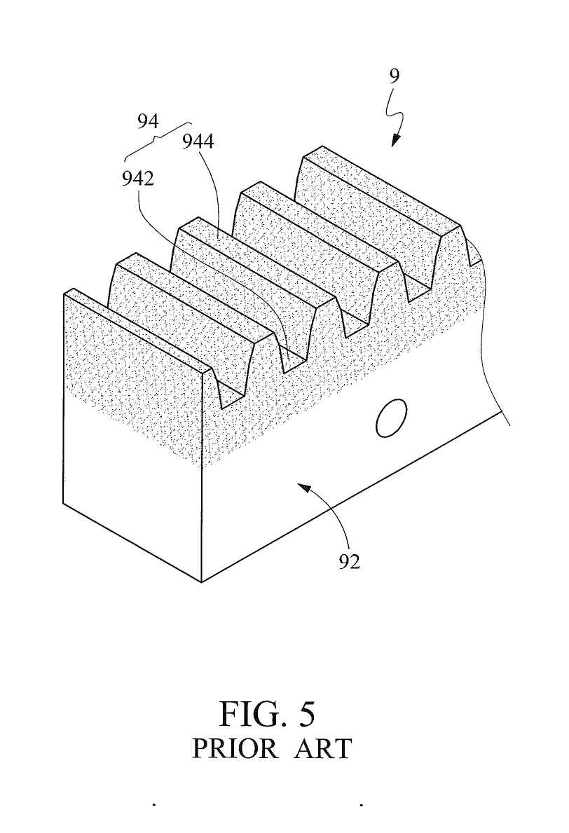

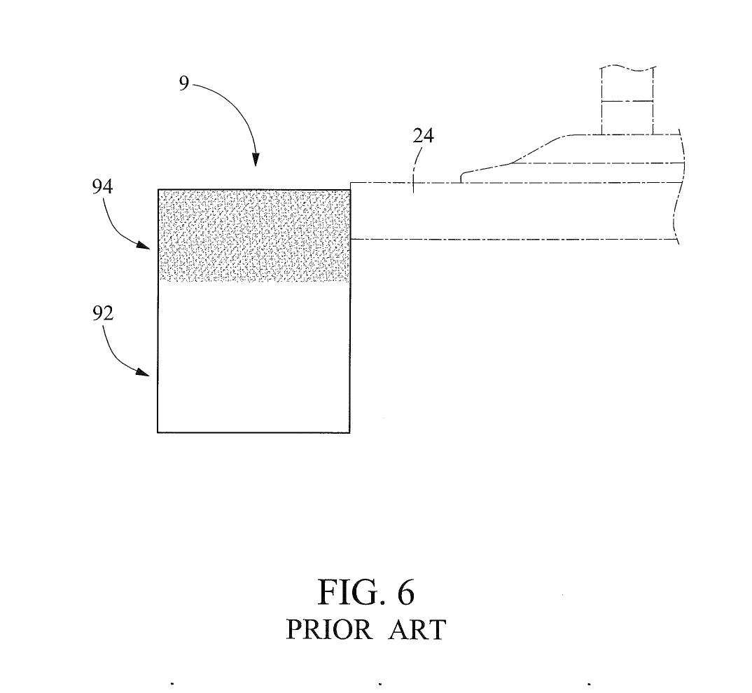

Referring to FIG. 4, a grinding wheel 24 is used to polish each of the lateral faces 16. An axle (not numbered) for rotating the grinding 24 is tilted, i.e., not directed vertically.

The hardness and/or roughness of the grinding wheel 24 are higher than that of the grinding wheel 22. Advantageously, the lateral faces 17 of the base 14 are properly polished with the grinding wheel 22 while the lateral faces 16 of the toothed portion 12 are properly polished with the grinding wheel 24.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A rack including:
a base 14 including two lateral faces 17; and
a toothed portion 12 extending on the base 14 and including two lateral faces 16 each extending from a corresponding one of the lateral faces 17 of the base 14 at an angle θ, thus forming a fold line 18 between each of the lateral faces 16 of the toothed portion 12 and the corresponding one of the lateral faces 17 of the base 14.

2. The rack according to claim 1, wherein the toothed portion 12 includes teeth 120 and spaces 126 for separating the teeth 120, and each of the teeth 120 includes a top land 122, and each of the spaces 126 includes a bottom land 124.

3. The rack according to claim 2, wherein the fold line 18 extends past the bottom lands 124.

4. The rack according to claim 2, wherein the fold line 18 extends below the bottom lands 124.

5. The rack according to claim 1, wherein the angle θ is larger than 0° and smaller than 20°.

6. The rack according to claim 1, wherein the teeth 120 are made of a height smaller than or identical to that of the toothed portion 12.

7. The rack according to claim 2, wherein the top land 122 is made of a width smaller than that of the base 14.

8. The rack according to claim 1, wherein the base 14 is made with at least one aperture 142.
